(19) United States
(12) Patent Application Publication
(10) Pub. No.: US 2015/0254600 A1
(43) Pub. Date: Sep. 10, 2015

(54) SYSTEM AND METHOD FOR REAL TIME ASSESSMENT OF CARGO HANDLING

(71) Applicant: Wipro Limited, Bangalore (IN)

(72) Inventors: Manjunatha Narasimha Murthy, Bangalore (IN); Savita Narain Narang, Bangalore (IN); Sushrutha Bankapura, Bangalore (IN); Panneer Selvam Jayaveera Pandian, Chennai (IN)

(73) Assignee: Wipro Limited, Bangalore (IN)

(21) Appl. No.: 14/257,322

(22) Filed: Apr. 21, 2014

(30) Foreign Application Priority Data
Mar. 5, 2014 (IN) 1120/CHE/2014

(51) Int. Cl. G06Q 10/08; G01H 17/00; G01C 9/00; G01L 5/00; G01K 13/00; G01N 25/56

(52) U.S. Cl. CPC G06Q 10/083; G01K 13/00; G01N 25/56; G01C 9/00; G01L 5/0052; G01H 17/00

(57) ABSTRACT

Disclosed herein are a method and a system for real time assessment of cargo handling. The method comprises: receiving a cargo plan for at least one stage of transportation of the cargo; creating at least one first sensor configuration corresponding to the at least one stage of transportation based on the cargo plan; enabling each of at least one first sensor configuration corresponding to the stage of transportation, the at least one first sensor configurations monitoring physical condition of the cargo and the at least one container; receiving dynamic data associated with the cargo and the at least one container; creating at least one context based on analysis of the dynamic data; enabling at least one second sensor configurations based on the at least one context; detecting damage to the cargo and the at least one container based on data received from the at least one second sensor configuration; recommending change in the cargo plan and repackaging of the cargo based on the damage.

### CROSS-REFERENCE TO RELATED APPLICATIONS

This application claims the benefit of Indian Patent Application Filing Number 1120/CHE/2014, filed on Mar. 5, 2014, which is hereby incorporated by reference in its entirety.

### FIELD

This disclosure relates generally to cargo handling, and more particularly to a method and a system for real time assessment of cargo handling.

### BACKGROUND

With rapid increase in cargo transportation across world, it can be seen that rough handling of goods has led to huge damages in transportation sector to the extent of losses of millions of dollars throughout the world. Currently, it is very difficult to qualify/quantify how the cargo was handled during its entire lifecycle and its correlation with various associated parameters such as cargo type, shipping mode, packing material used etc.

Further, it becomes very difficult to correlate condition/damages to the context in which cargo was transported as the condition of the cargo is known only at final destination.

Also with lack of real time indication against current cargo handling mode, it is not possible to take corrective control measures.

The above mentioned issues lead to unavailability of mechanism to determine appropriate model (such as sensors and modes) for transporting the cargo.

Therefore, in view of above drawbacks, there is a need for real time assessment of cargo handling and take corrective measures to prevent the damage to the cargo.

### SUMMARY

Disclosed herein is a method for real time assessment of cargo disposed in at least one container, the method includes receiving a cargo plan for at least one stage of transportation of the cargo; creating at least one first sensor configuration corresponding to the at least one stage of transportation based on the cargo plan; enabling each of at least one first sensor configuration corresponding to the stage of transportation, the at least one first sensor configurations monitoring physical condition of the cargo and the at least one container; receiving dynamic data associated with the cargo and the at least one container; creating at least one context based on analysis of the dynamic data; enabling at least one second sensor configurations based on the at least one context; detecting damage to the cargo and the at least one container based on data received from the at least one second sensor configuration; recommending change in the cargo plan and repackaging of the cargo based on the damage.

In another aspect of the invention, a system for real time assessment of handling of cargo disposed in at least one container is disclosed. The system includes at least one processor, a memory coupled to the at least one processor, the memory storing instructions which when executed by the processor causes the processor to: receive a cargo plan for each of the plurality of stages of transportation of the cargo; create at least one first sensor configuration corresponding to at least one stage of transportation based on the cargo plan; enable each of at least one first sensor configuration corresponding to the stage of transportation, the at least one first sensor configurations monitoring physical condition of the cargo and the at least one container; receive dynamic data associated with the cargo and the at least one container; create at least one context based on analysis of the dynamic data; enable at least one second sensor configurations based on the at least one context; detect damage to the cargo and the at least one container based on data received from the at least one second sensor configuration; recommend change in the cargo plan and repackaging of the cargo based on the damage.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates general environment in which various embodiments of the present disclosure may function.

FIG. 2A-2B is a flowchart for real time assessment of cargo handling in accordance with some embodiments.

FIG. 3 illustrates creation of various sensor configurations in accordance with some embodiments.

FIG. 4 is a flowchart for prediction of damage that the cargo and the container have undergone in accordance with some embodiments.

FIG. 5 is a block diagram of a system for real time assessment of cargo handling in accordance with some embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

The present disclosure discloses a system and a method of assessing handling of cargo by determining a context of a cargo using a movement of the cargo, stage of transportation and route of cargo vehicle with help of a GPS, an accelerometer and other sensor data. Selective sensors may be enabled to monitor relevant parameters based on the dynamic context. The damage may be detected. If there is no damage detected, the damage the cargo may undergo may be predicted based on events occurred. The damage cargo has undergone may be quantified and score may be assigned to the cargo handling for each stage by analyzing aggregated sensor data. Subsequently a profile of the cargo handler may be created by aggregating scores for multiple shipments.

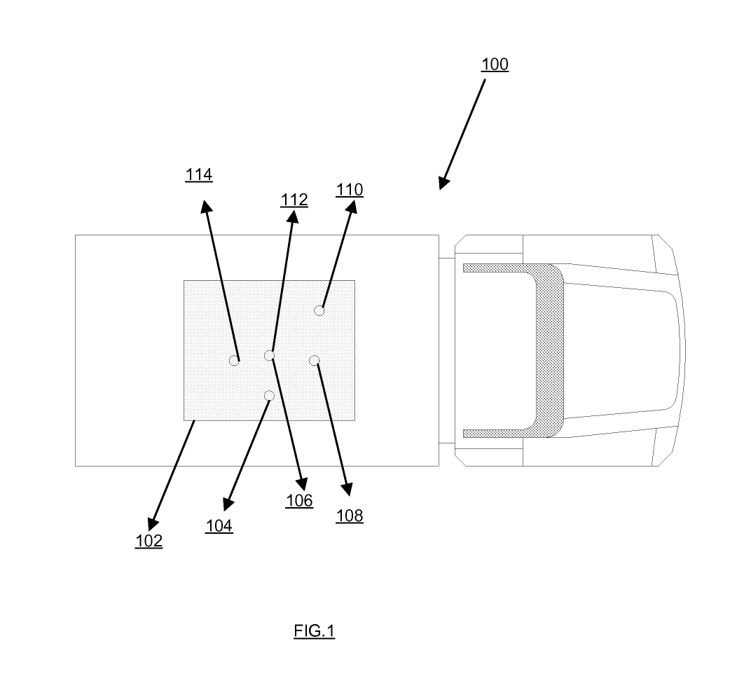

FIG. 1 illustrates general environment in which various embodiments of the present disclosure may function. Shown in the figure is a truck 100 that is a mean of transportation of the cargo. It should be apparent to a person of ordinary skill in the art that other means of transportation may be used like railway, ship, and aircraft. Consequently, there may be different modes of shipment like by rail, road, water. Further, there may be a container 102 disposed in the truck 100. The container 102 may be a corrugated box, a boxboard, woodbox, crates, barrels, and casks. It should be apparent to a person of ordinary skill in the art that there may be more than one container 102. Sensors (104, 106, 108, 110, 112, and 114) may be mounted on the container 102 to monitor parameters associated with physical condition of the cargo. Further, sensors (104, 106, 108, 110, 112, and 114) may also be attached to the cargo disposed in the container 02. The sensors may be mounted on the container 102 and may be attached to the cargo to predict possibility of the cargo getting damaged and possibility of the container 102 getting damaged. The sensors (104, 106, 108, 110, 112, and 114) may be temperature sensor, shock sensor, acoustic sensor, terrain specific sensor, vibration sensor, luminance sensor etc. This is an illustrative list only and not exhaustive list of sensors.

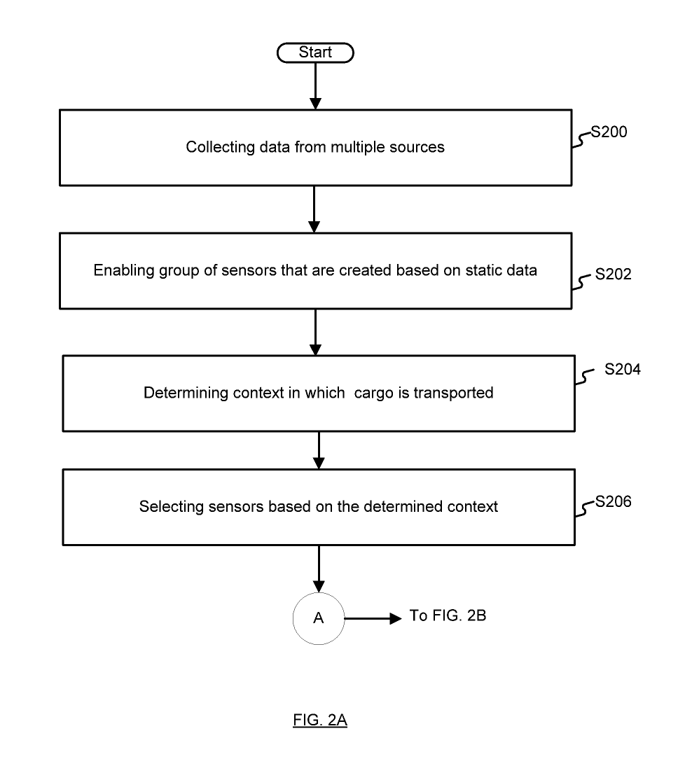

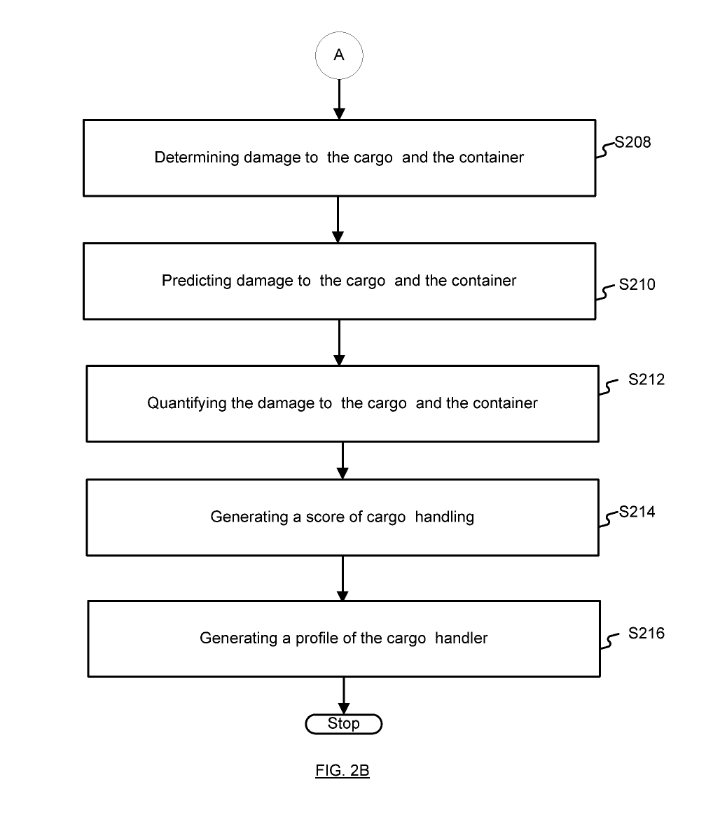

FIG. 2 is a flowchart for real time assessment of cargo handling in accordance with some embodiments. At step S200, data is collected from multiple sources. The data could be related to shipment like cargo plan (cargo type, mode of transportation, date of shipping etc.) or relevant information like weather data, traffic data or route data. Data could also be collected from sensors (104, 106, 108, 110, 112, and 114). The data may be related to temperature, humidity, location, etc. The data could also be obtained indirectly, e.g. how many times cargo package was dropped, how much extra time it took to reach destination, etc.).

Data may be categorized into:
1). Static data: This is based on already available data on the cargo, e.g.,
Cargo type
Duration of Journey
Mode of shipping
Type of Package
   2). Dynamic data: This is obtained in real time during shipment, e.g.,
1. Material state like in-transport/stationary
2. Place or location
3. Events like thresholds crossed for temperature/moisture, tilt, shock level or vibrations
   The above static/dynamic data provides inputs for creating groups of the sensors (104, 106, 108, 110, 112, and 114).

There are two groups of sensors that are created based on the cargo plan and real time conditions that occur during cargo handling. One group of sensors is based on static data and the other group of sensors is based on dynamic data.
Static groups of sensors are created based on properties specific to each cargo/container and the available cargo plan. Example if cargo shipping requires cold storage time according to plan, a group of sensors will be created to measure temperature at cold storage comprising associated sensor data like location, time, and external sensor data of the cold storage.
Dynamic groups of sensors are created based on occurrence of events which demands requirement of associated sensor data for further analysis. As the shipment advances, different dynamic groups are created.

At step S202, a group of sensors that are created based on static data are enabled. The group of sensors is created based on the cargo plan. Cargo transportation needs specific sensors to be enabled based on the cargo plan at various stages of cargo transportation.
Each of static groups of sensors identifies a specific sensor configuration. Each sensor configuration specifies a list of sensors to be used, patterns to be detected, triggers at which sensor should be used and possibly priority.
The static group that needs to be used is pre-set at origination of the cargo. The association of the static group of sensors with a cargo is dependent on the cargo plan. The attributes of a static group are given below for a few sensor examples:

| | | | Trigger Criteria |
|---|---|---|---|
| | | Detection Pattern | (event based, |
| | Sensor/Sensor | (Value type data, | time based, |
| SI. No. | Group Id | waveforms, images) | location based) |
| 1 | Vibration | FFT | “Only during |
| | Sensor | | transit” |
| 2 | Luminance | Intensity and | “Only when |
| | sensor | duration | cargo is |
| | | | tampered” |

The cargo plan consists of cargo specifications, packaging specifications, transport specifications, handling stage. Some of the attribute of the cargo plan is grouped and enumerated as below. A few examples are given below:

| | |
|---|---|
| Transportation Mode | Road, Rail, Ship |
| Handling Stage | Uploading, stationary, moving |
| Location | In transit, warehouse |
| Packaging Type | Cardboard, wooden crate |

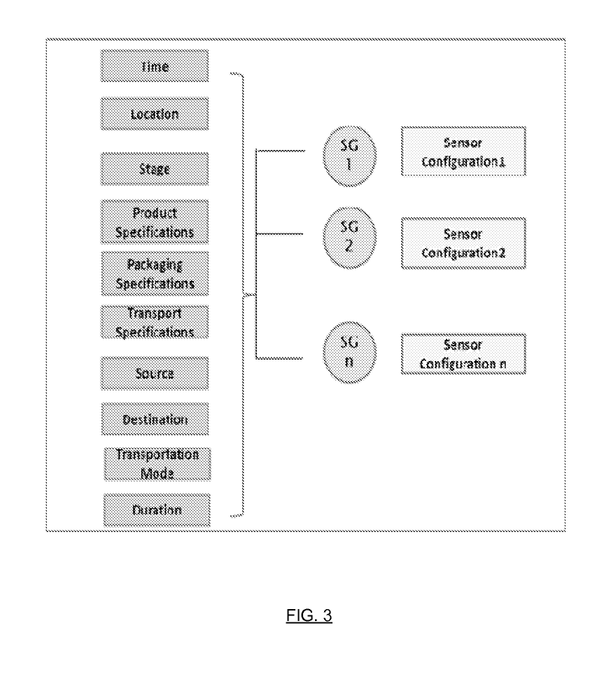

As and when the cargo is shipped, specific sensor configuration may be enabled and used. FIG. 3 illustrates creation of various sensor configurations (sensor configuration 1, sensor configuration 2, and sensor configuration 3) based on various factors associated with the cargo plan like time, location, stage, product specifications, packaging specifications, transport specifications, source, destination, transportation mode, and duration.

At step S204, the context of the cargo may be determined. Data from the sensors (104, 106, 108, 110, 112, and 114) may be collected on start of the cargo transportation. Data from each sensor group may be collected. The sensor/event data may determine context of cargo. The data may be analyzed based on the stages of transportation like:
container is stationary/in-motion;
container is in transit like loading from one vehicle/warehouse to another vehicle/warehouse; or
container is in storage.
   Static groups specify sensor configurations based on the cargo plan, but do not take into account changes in the real world and many of which are transient in nature. This may impact damage prediction and quantification. Dynamic grouping of sensors may help in determining
a. Cargo condition with higher precision by enabling the appropriate sensor configuration associated with the context.
b. Enhance the knowledge base by analyzing the dataset associated with the new context.
   A few examples include:
Enable sensors for monitoring tampering, when the cargo is transferred in an area where there is a riot/natural calamity.
Enhance the sampling rate of temperature sensors when the cargo container is opened for more than a specific duration.
Enable shock sensors at the top of the cargo when there is an item of heavy weight placed on the cargo.
Enable acoustic sensors when a fragile material is being transported on detection of frequent internal displacement.
Enable CO2 sensors on detecting rate of change of temperature beyond the threshold which can be used for freshness determination.
Enable specific sensors based on change in the route (e.g., terrain specific sensors).
   To determine the context, the factors that may be considered include cargo specific attributes such as location, time, condition and external attributes such as climatic conditions, geographical conditions (such as terrain), other real world events (e.g., congestion, shutdowns etc.).

At step S206, sensors may be selected based on the determined context that is dynamic. The selected sensors may be enabled. It is to be noted that the context may be different for different stages of transportation. Accordingly, the sensor configurations may be activated and deactivated as per the dynamic context. Also, the thresholds for the sensors may be changed based on the changing context.

Grouping of sensors may help to determine the condition of the cargo in a meaningful way. For example, vibration events in the vehicle may be correlated with speed of the vehicle and external environment as well as driver skill to provide condition of the cargo.

An important aspect of the assessment of the cargo handling is damage quantification and damage prediction. At step S208, the damage the cargo has undergone is determined. Also, the damage to the container 102 is detected. Sensor data is first analyzed to detect pattern for damages. Damage detection may be done by identifying patterns and thresholds from the sensor data. The sensor data patters may be matched with those stored in a knowledge base specific to the cargo. Typical techniques include fast fourier transform (FFT), spectral distance, and discrete wavelet transform (DWT).

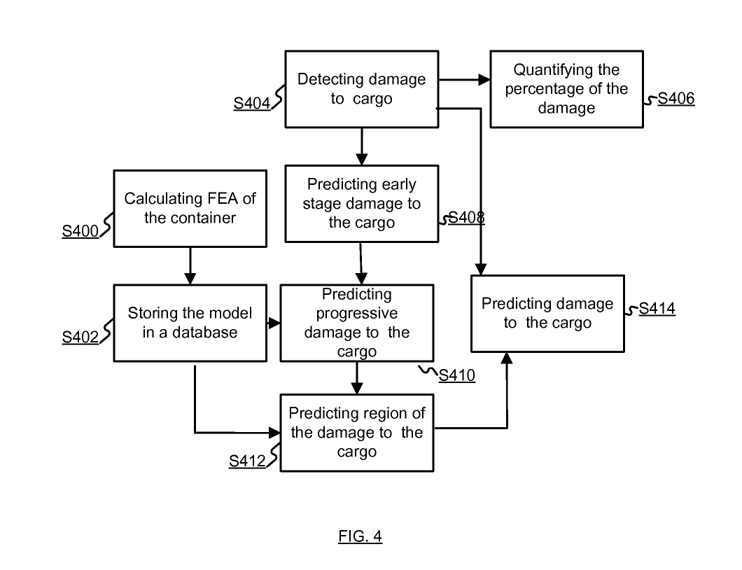

At step S210, the damage the cargo and the container 102 may undergo may be predicted. Prediction of the damage to the cargo may be done when there is no damage detected or there is some degree of damage that has been done to the cargo and the container 102. FIG. 4 illustrates a flowchart for prediction of damage that the cargo has undergone in accordance with some embodiments.

Shown in the FIG. 4 is the prediction of early stage damage, progressive damage, region of damage, damage to the cargo.

At step S400, FEA (Finite Element Analysis) may be performed to obtain behavior of the container 102 with specific design parameters at different scenarios. A virtual database may be created to observe the behavior of the container 102 at different scenarios of the container 102 like variation in vibration, load bearing conditions etc. (Step S402).

At step S404, the damage to the cargo is detected. Based on damage to the cargo, the damage is quantified in terms of percentage (S406). Based on output of the damage detection, in case there is no damage detected, various types of statistical techniques will be used for damage prediction.
a. At step S408, early stage damage is predicted. Initially when there is limited amount of data obtained from the cargo, a Binary Classifier such as Multi-layer perceptron network, may be used to detect possibility of damage or no damage conditions. The Binary Classifier may indicate possibility of damage or not, but cannot predict multiple levels of damage condition.
b. At step S410, progressive damage is predicted. As and when the condition of the cargo deteriorates, data available for analysis is higher. Hence a finer classifier such as RBNF (radial basis function network) may be used. This classifier may help detect damage possibility in a more refined manner and enable prediction at a higher accuracy.

At step S412, region of damage is predicted, the FEA model stored in the database (step S402) and the damage prediction information may be used as inputs
a. In cases where the damages are highly localized, Fuzzy Neural Networks technique may be used.
b. In cases where the damage is scattered, an ensemble of neural network technique may be used.
c. The above analysis may provide local and scattered damage patterns and mapping of damage in two dimensional space for the container 102 housing the cargo.

Finally, at step S414, the damage to the cargo is predicted:
a. The effect of container damage on the cargo may be first done using correlation analysis techniques.
b. Multivariate regression analysis may be done on the sensor data, given container condition, location of container damage (obtained from previous steps) and environmental data to predict the damage to the cargo.

Damage prediction may provide information about the probability of damage due to external/internal environmental impact during entire shipment. The damage may be predicted based on the dynamic conditions and will be specific to container 102 and cargo inside the container 102. The prediction of damage of the container 102 provides information on container state during the shipment and possible repackage options can be indicated to prevent further damage. Based on the current condition of shipment, system can provide suggestions on new shipment plan and/or repackaging options to avoid further damage.

Damage quantification: At step S212, once the damage is detected, the sensor data may be further analyzed to quantify the damage by using supervised self-organized mapping (SSOM) technique. SSOM algorithm provides propagation of damage on two dimensional map. The peak values may be identified, thereby calculating percentage area of damage.
On perishable goods the location and area of high respiration rate may be calculated to quantify the damage.
On non-perishable goods like fragile material the area of damage may be calculated based on vibration analysis to quantify the damage.

At step S214, generate a score of cargo handling: a numeric score of damage level on a scale of 1-4 is given in the table below:

TABLE 1
Damage Level

| Level | Material Damage | Damage wrt Packaging |
|---|---|---|
| 1 | Full product needs to be | Packing needs to be |
| | replaced | replaced |
| 2 | Portion of the product | Portion of the package |
| | needs to be replaced | needs to be replaced |
| 3 | Damaged but can be used | Damaged but can be used |
| 4 | No damage | No Damage |

The scale mentioned above is used both for identifying the damage Level for the cargo and the container 102 housing the cargo.
   Damage information of both the cargo and the container 102 may be used.
   The region of damage information and the percentage of damage provided may be taken and the damage level may be identified from the information stored in a product database.
   In case there are multiple damages, the damage levels of each of them may be taken and that which has the highest impact on the cargo may be used for creating the score.
   A simple weighting matrix may be created for each cargo type, with weights associated for both cargo and the container 102.
   A final score may be arrived at using the weighted matrix associated with the cargo being transported. Samples of the Score Weighting Matrix is given below in the table.

TABLE 2
Score Weighting Matrix

| | | Container Damage |
|---|---|---|
| Goods Type | Cargo Damage Level | Level |
| High Value goods | 80% | 20% |
| Perishable goods | 70% | 30% |
| Clothes | 60% | 40% |

An example of the Cargo Handling Scorecard is given below:

TABLE 3
Cargo Handling Scorecard

| | | Container | |
|---|---|---|---|
| Cargo | Cargo | Damage | Final |
| Item | Damage Level | Level | Score |
| TV | 1 | 2 | 1.20 |
| Oranges | 2 | 2 | 2.00 |

At step S216, a profile of cargo handler is created. The cargo handlers are profiled across various parameters which then can be used for decision making by the handlers themselves, by manufacturers or even by end consumers. The parameters that are used to create the cargo handler profile are as follows, but not restricted to below parameters.

Mode of shipping:
i) Rail
ii) Road
iii) Marine
iv) Air

Packaging and Packing Materials
i) corrugated box
ii) boxboard
iii) wood box
iv) crates
v) barrels and casks

Type of Region coverage:
i) Inter-continental/different geographies
ii) Inter-Country
iii) Inter-State
iv) Inter-city
v) Local/Domestic

Type of Terrain
i) Plain
ii) Hilly

Duration of Journey:
i) Months
ii) Weeks
iii) Days
iv) Hours

Type of Transport hazards:
i) shock (e.g. from dropping, side impacts)
ii) compression (from top loads)
iii) vibration
iv) changes in atmospheric pressure (in aircraft holds)
v) atmospheric pollution (sulphates in industrial environment, chlorides in marine environment)
vi) moisture, water (rain, high humidity, condensation, spillage)
vii) oxidation
viii) extreme temperature (hot or cold)
ix) electrostatic discharge

Geographic familiarity

Product Type
i) Perishable
ii) Textiles
iii) Electronics
iv) Glass, porcelain
   These are only illustrative examples that may be used for creating the profile. Also, the parameters may be combined in different ways for defining a cargo profile.
   Using the above profile, ranking of cargo handler can be done based on various parameters like
Condition of the material at arrival/destination/ports
Transportation methods
Amount of time taken to reach destination
Delay in delivery at various stages of transportation
   For every cargo item that was shipped, a record is generated to capture the various attributes associated including product information, context information, schedule information, cargo handling score and damage prediction information. A sample of this is given below

TABLE 4

| Cargo | Cargo | Material | Time | Cargo | Damage | Transportation | |
|---|---|---|---|---|---|---|---|
| Item | Handler | Type | adherence | Handling Score | Probability | mode (s) | Geography |
| LCD | XYZ | Fragile | On time | 1.2 | High | Truck | India |
| TV | Inc | | | | | | |

Each of the entries may be then aggregated to create a profile. The profile can be created comparing cargo handlers for a specific shipment mode across one of or a combination of the above attributes. Here the shipment mode is used as the attribute to compare. The profile will comprise of the Cargo Handling Index, the Safety Index and the Time adherence. These indices are relative and can be measured using a scale such as the one below:
1—Bad handling
2—Closer to thresholds
3—Aligns with Group
4—Ideal

The cargo handling index is generated by comparing the aggregated cargo handling scores across multiple shipments. Similarly, the safety index is arrived at by aggregating the damage prediction scores. Time adherence refers to deviations in time lines and schedules. The profile may look like as given in the following two tables.

TABLE 5
Profile for Cargo Type xyz wrt shipper and shipment mode

| Shipment | Cargo Handler | | |
|---|---|---|---|
| Mode | Shipper 1 | Shipper 2 | Shipper 3 |
| Train | Cargo Handling Index | Cargo Handling | Cargo Handling |
| | | Index | Index |
| | Safety Index | Safety Index | Safety Index |
| | Time adherence | Time adherence | Time adherence |
| Ship | Cargo Handling Index | Cargo Handling | Cargo Handling |
| | | Index | Index |
| | Safety Index | Safety Index | Safety Index |
| | Time adherence | Time adherence | Time adherence |
| Truck | Cargo Handling Index | Cargo Handling | Cargo Handling |
| | | Index | Index |
| | Safety Index | Safety Index | Safety Index |
| | Time adherence | Time adherence | Time adherence |
| Ware- | Cargo Handling Index | Cargo Handling | Cargo Handling |
| house | | Index | Index |
| | Safety Index | Safety Index | Safety Index |
| | Time adherence | Time adherence | Time adherence |

TABLE 6
Profile for Cargo Type xyz wrt shipper and geography

| | Cargo Handler | | |
|---|---|---|---|
| Geography | Shipper 1 | Shipper 2 | Shipper 3 |
| Country/ | Cargo Handling | Cargo Handling | Cargo Handling |
| State/ | Index | Index | Index |
| Next level | Safety Index | Safety Index | Safety Index |
| | Time adherence | Time adherence | Time adherence |
| Country/ | Cargo Handling | Cargo Handling | Cargo Handling |
| State/ | Index | Index | Index |
| Next level | Safety Index | Safety Index | Safety Index |
| | Time adherence | Time adherence | Time adherence |
| Country/ | Cargo Handling | Cargo Handling | Cargo Handling |
| State/ | Index | Index | Index |
| Next level | Safety Index | Safety Index | Safety Index |
| | Time adherence | Time adherence | Time adherence |

It should be apparent to a person skilled in the art that there may be more categories of adherences and scales for profiles created with different attributes.

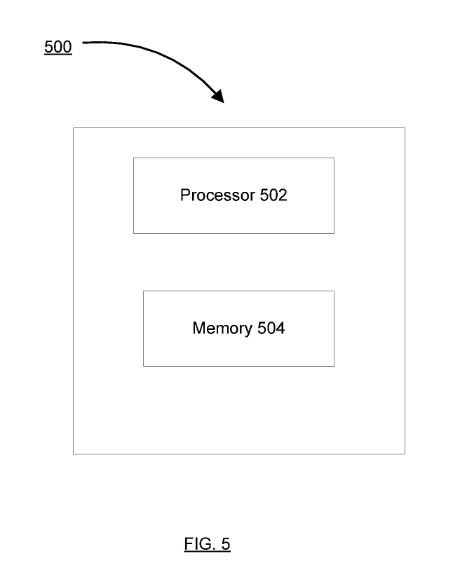

FIG. 5 is a block diagram of a system 500 for real time assessment of cargo handling in accordance with some embodiments. The memory 504 of the system 500 may include instructions that are executable by processor 502 to optimize process of real time assessment of cargo handling in accordance with some embodiments of this disclosure. The processor 502 may receive a cargo plan for at least one stage of transportation of the cargo. This is followed by creating at least one first sensor configuration corresponding to the at least one stage of transportation based on the cargo plan. The processor 502 enables each of at least one first sensor configuration corresponding to the stage of transportation, the at least one first sensor configurations monitoring physical condition of the cargo and the at least one container. The processor 502 may receive dynamic data associated with the cargo and the at least one container. Then a context is created based on analysis of the dynamic data. The processor then enables a second sensor configurations based on the at least one context. The damage to the cargo and the at least one container is detected based on data received from the at least one second sensor configuration. The processor 502 then recommends change in the cargo plan and repackaging of the cargo based on the damage.

The illustrated steps are set out to explain the exemplary embodiments shown, and it should be anticipated that ongoing technological developments will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for real time assessment of handling of cargo disposed in at least one container, the method comprising:
receiving a cargo plan for at least one stage of transportation of the cargo;
creating at least one first sensor configuration corresponding to the at least one stage of transportation based on the cargo plan;
enabling each of at least one first sensor configuration corresponding to the at least one stage of transportation, the at least one first sensor configuration monitoring physical condition of the cargo and the at least one container;
receiving dynamic data associated with the cargo and the at least one container;
creating at least one context based on analysis of the dynamic data;
enabling at least one second sensor configuration based on the at least one context;
detecting damage to the cargo and the at least one container based on data received from the at least one second sensor configuration; and
recommending change in the cargo plan and repackaging of the cargo based on the damage.

2. The method of claim 1, wherein the dynamic data comprises at least one of a cargo state, a location of the cargo, thresholds crossed for temperature/moisture, tilt, and shock level/vibrations.

3. The method of claim 1, further comprising quantifying the damage to the cargo and the at least one container.

4. The method of claim 1, wherein the cargo plan comprises at least one of a source, destination, transportation mode, duration, transport specifications, product specifications, packaging specifications, stage of transportation, location, and time.

5. The method of claim 1, wherein the at least one first sensor configuration specifies a list of sensors used, patterns to be detected, triggers at which the list of sensors to be used.

6. The method of claim 1, further comprising predicting damage after detecting the damage to the cargo and the at least one container.

7. The method of claim 6, wherein the damage is predicted by identifying patterns and thresholds captured from dynamic data.

8. The method of claim 6, wherein predicting the damage further comprises predicting early stage damage and a progressive damage to the cargo and the at least one container.

9. The method of claim 1, further comprising generating a score of cargo handling based on the damage to the cargo and the at least one container.

10. The method of claim 1, wherein damage level is determined based on region of damage and percentage of damage.

11. The method of claim 9, wherein a weighting matrix is created for each cargo type with weights associated for both cargo and the at least one container.

12. The method of claim 11, wherein a final score is determined using the weighted matrix created for both the cargo and the at least one container.

13. The method of claim 1, further comprising creating a profile of a handler based on cargo handling index, safety index, and time adherence.

14. A system for real time assessment of handling of cargo disposed in at least one container, the system comprising:
at least one processor;
a memory coupled to the at least one processor, the memory storing instructions which when executed by the processor causes the processor to:
receive a cargo plan for each of the plurality of stages of transportation of the cargo;
create at least one first sensor configuration corresponding to at least one stage of transportation based on the cargo plan;
enable each of at least one first sensor configuration corresponding to the stage of transportation, the at least one first sensor configurations monitoring physical condition of the cargo and the at least one container;
receive dynamic data associated with the cargo and the at least one container;
create at least one context based on analysis of the dynamic data;
enable at least one second sensor configurations based on the at least one context;
detect damage to the cargo and the at least one container based on data received from the at least one second sensor configuration; and
recommend change in the cargo plan and repackaging of the cargo based on the damage.

15. The system of claim 14, wherein the dynamic data comprises at least one of a cargo state, a location of the cargo, thresholds crossed for temperature/moisture, tilt, and shock level/vibrations.

16. The system of claim 14, wherein the cargo plan comprises at least one of a source, destination, transportation mode, duration, transport specifications, product specifications, packaging specifications, stage of transportation, location, and time.

17. The system of claim 14, wherein at least one first sensor configuration specifies a list of sensors used, a patterns to be detected, triggers at which the list of sensors to be used.

18. The system of claim 14, wherein the damage is predicted after predicting the damage to the cargo and the at least one container.

19. The system of claim 14, wherein a score of cargo handling is generated based on the damage to the cargo and the at least one container.

20. The system of claim 14, wherein damage level is determined based on region of the damage and percentage of the damage.

21. The system of claim 14, wherein a weighting matrix is created for each cargo type with weights associated for both the cargo and the at least one container.

22. The system of claim 21, wherein a final score is determined using the weighted matrix created for both the cargo and the at least one container.

23. The system of claim 14, wherein a profile of a handler is created based on cargo handling index, safety index, and time adherence.

24. A non-transitory computer-readable medium storing instructions for real time assessment of handling of cargo disposed in at least one container that, when executed by one or more hardware processors, cause the one or more hardware processors to perform operations comprising:
receiving a cargo plan for each of the plurality of stages of transportation of the cargo;
creating at least one first sensor configuration corresponding to at least one stage of transportation based on the cargo plan;
enabling each of at least one first sensor configuration corresponding to the stage of transportation, the at least one first sensor configurations monitoring physical condition of the cargo and the at least one container;
receiving dynamic data associated with the cargo and the at least one container;
creating at least one context based on analysis of the dynamic data;
enabling at least one second sensor configurations based on the at least one context;
detecting damage to the cargo and the at least one container based on data received from the at least one second sensor configuration;
recommending change in the cargo plan and repackaging of the cargo based on the damage.

25. The non-transitory computer-readable medium of claim 24, wherein the dynamic data comprises at least one of a cargo state, a location of the cargo, thresholds crossed for temperature/moisture, tilt, and shock level/vibrations.
